(19) United States
(12) Patent Application Publication
(10) Pub. No.: US 2002/0040262 A1
(43) Pub. Date: Apr. 4, 2002

(54) Method and device for driving a final controlling element exhibiting hysteresis

(76) Inventor: Christian Weber, Schwieberdingen (DE)

Correspondence Address: KENYON & KENYON, ONE BROADWAY, NEW YORK, NY, 10004, US

(21) Appl. No.: 09/944,745

(22) Filed: Aug. 31, 2001

(30) Foreign Application Priority Data
Sep. 2, 2000 (DE) 100 43 254.9

(51) Int. Cl. G06F 7/00

(52) U.S. Cl. 701/1; 701/93

(57) ABSTRACT

A method and a device for driving a final controlling element exhibiting hysteresis are proposed. In this context, the drive quantity for the final controlling element is corrected by an offset value as a function of the change over time of the drive quantity, this value being limited to a variable value.

### FIELD OF THE INVENTION

The present invention relates to a method and a device for driving a final controlling element exhibiting hysteresis.

### BACKGROUND INFORMATION

Hysteresis-exhibiting final controlling elements are used in a plurality of technical fields of application. In the field of motor vehicle engineering, such valves are used, for example, for regulating traveling speed (see U.S. Pat. No. 5,854,989), for controlling or regulating brake pressure (see German Published Patent Application No. 198 48 960, for example), or also for controlling an internal combustion engine. Such final controlling elements can exhibit hysteresis, which can be quite high, at least in some cases. In this case, when changing the drive quantity, particularly the drive current, the quantity to be controlled or regulated only changes when the drive quantity changes relatively significantly. Hysteresis can only be overcome in this manner. In the case of smaller changes in the drive quantity, the quantity to be controlled or regulated does not change. Hysteresis can result in undesired fluctuations in the quantity to be controlled or regulated as well as in the driving itself. Such fluctuations are particularly unpleasant when the final controlling element is used in conjunction with a vehicle speed controller or a wheel brake (braking system). In this case, hysteresis can result in fluctuations in the vehicular speed or the brake pressure, in the braking force, or in the brake torque at the wheel brakes during the regulating operation, which can be extremely unpleasant for the driver of the vehicle. Examples of such hysteresis-exhibiting final controlling elements are valves configured as proportional valves or operated in a proportionalizing manner via a special drive circuit.

### SUMMARY OF THE INVENTION

As a result of the effect of the drive quantity on the final controlling element (valve) described in the following, the hysteresis problem and the danger of fluctuations in the driving and/or in the quantity to be regulated or controlled are largely eliminated.

It is particularly advantageous that this success occurs independently of the magnitude of the hysteresis, no disadvantageous effects being exhibited in the case of final controlling element specimens having low hysteresis.

As a result of the subsequently represented procedure, the drive quantity is changed by a certain offset value, as a function of the dynamic response of the drive quantity. This has the advantageous effect that the hysteresis is passed through more quickly, and the quantity influenced by the final controlling element follows the setpoint value significantly more quickly. The dependence of the drive quantity on its dynamic response in the case of final controlling elements having low hysteresis is modified in such a manner that there is no irregularity in the regulation or control, every change of the drive quantity by the offset value being effectively prevented from affecting the quantity to be controlled or regulated.

It is particularly advantageous that the drive quantity is adaptively corrected, so that manufacturing tolerances with respect to hysteresis in the case of final controlling elements can be disregarded, and the driving can be automatically adapted to the hysteresis of the sample used.

### BRIEF DESCRIPTION OF THE DRAWINGS

FIG. 1 shows an overview of a circuit diagram of a control device for controlling a hysteresis-exhibiting final controlling element within the framework of at least one performance quantity being controlled or regulated.

FIG. 2 shows a first flow charts to show the drive quantity being changed as a function of its dynamic response and of the adaptation of this correction to the currently existing specimen of the final controlling element, the flow chart outlining a preferred embodiment of this procedure as a program of the microcomputer of the control device.

FIG. 3 shows a second flow charts to show the drive quantity being changed as a function of its dynamic response and of the adaptation of this correction to the currently existing specimen of the final controlling element, the flow chart outlining a preferred embodiment of this procedure as a program of the microcomputer of the control device.

### DETAILED DESCRIPTION

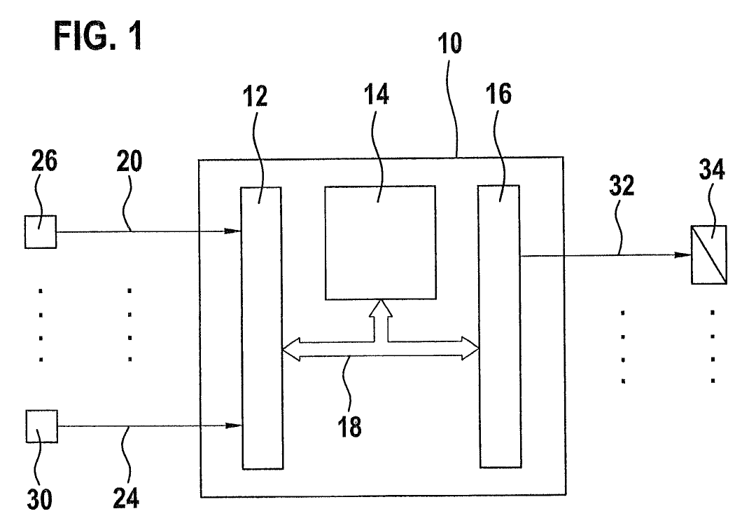

FIG. 1 shows a control device 10 having an input circuit 12, at least one microcomputer 14, and an output circuit 16. These elements are connected to one another via a communication system 8. Leading in to the input circuit are input lines 20 through 24, which transmit performance quantities from measuring devices 26 through 30, the performance quantities being evaluated for carrying out the control tasks or regulation tasks of control unit 10. Via at least one output line 32, control unit 10 drives at least one hysteresis-exhibiting final controlling element 34, preferably at least one valve or one valve configuration.

Stored in microcomputer 14 of control unit 10 are programs, which, as a function of the supplied input variables, generate output variables for carrying out at least one control task or regulation task, which helps to operate the at least one final controlling element 34. As represented in the related art cited at the outset, microcomputer 14 carries out a vehicle speed control or limitation, for example, the output signal being formed as a function of the difference between a predefined setpoint value or limiting value and the actual vehicle speed value. In the case of a braking control system, e.g. on the basis of a driver's desired braking value, such as the deflection of the brake pedal, at least one final controlling element assigned to the wheel brake, preferably a valve, is operated in such a manner that a braking pressure derived from the desired braking, a braking force, or a braking torque is adjusted to this wheel brake. In this context, another embodiment represents the control of at least one valve, which provides an amplification factor between the operating force of the driver and the braking force, so that the customary power brake unit is used or supported. While in a first exemplary embodiment a proportional valve is preferably used, valves that are driven in such a manner that they have proportional characteristics are preferably used in the other exemplary embodiments. This means that they are controlled so as to reach predefined positions outside of the completely closed or completely open position. Further application cases in which hysteresis-exhibiting final controlling elements, such as valves or electrical motors, are used, are speed control systems, closed-loop position controls in connection with an internal combustion engine, etc., for example.

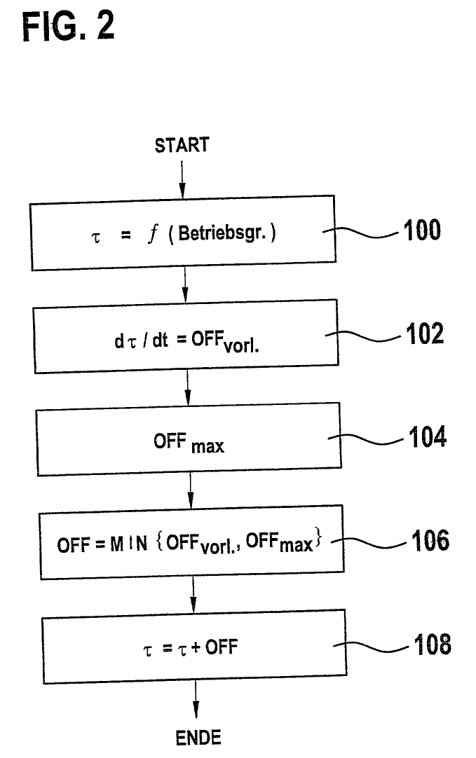

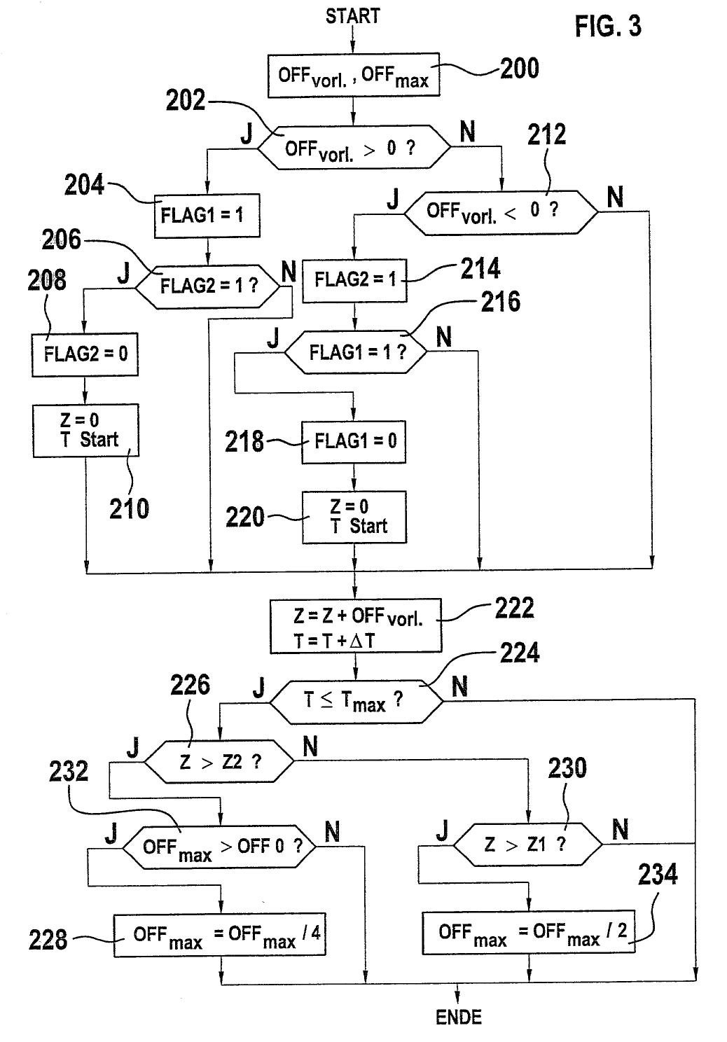

To counter this problem of the tendency to fluctuate indicated at the outset, programs that correct the drive signal quantity as a function of its dynamic response are also implemented in microcomputer 14. As a result, the effects of even high final controlling element hystereses on the control quality can be reduced without the occurrence of disadvantages in the case of lower hystereses. Examples of such programs are shown in FIGS. 2 and 3 as flow charts.

The program represented in FIG. 2 is executed during operation, in predefined time intervals. After the start, in a first step 100, a variable quantity τ of the drive signal (called the drive quantity in the following) is formed for the final controlling element (called the valve in the following) as a function of the performance quantities forming the basis for the control or regulation, or of the measured performance quantities or of the calculated performance quantities. In this context, depending on the type of drive signal, drive quantity τ represents at least one variable quantity, e.g. a pulse control factor, an amplitude, a frequency, etc. In subsequent step 102, the change over time dτ/dt of this drive quantity τ is determined, preferably as the time derivation or as the difference of two values ascertained at different sampling instants having set time intervals. The value of the change over time is set as a provisional offset value OFFVORL. In subsequent step 104, maximum offset value OFFMAX, which is determined according to the program represented in FIG. 3, is input. In next step 106, offset value OFF is then set to the smaller of these values (provisional or maximum offset value) and applied (e.g. added) to drive quantity τ in step 108. A drive signal having the corrected drive quantity τ is then output for driving the valve. The program is then concluded and executed anew at the next time interval with step 100.

In other words, a provisional offset value for the drive quantity is formed from the change over time of the drive quantity, i.e., its dynamic response. This provisional offset value is limited to a preferably variable maximum value. The drive quantity output as a drive signal is then determined by correcting the calculated drive quantity using the offset value, which is limited if necessary.

As a result of this measure, the effect of the final controlling element hysteresis on the regulating performance or controlling performance is effectively decreased or eliminated, at least in the case of high hystereses. In the case of a valve having low hysteresis, it was shown, however, in several application cases that the regulation performance of control performance can deteriorate as a result of the offset value. However, since the drive signal is to be formed independently of manufacturing tolerances, limiting value OFFMAX is adaptively adjusted to the valve in question in these application cases. A preferred embodiment is shown in the flow chart in FIG. 3.

The starting point of this design approach is that, in the case of a valve having high hysteresis, the drive quantity for the valve and, as such, also the provisional offset value typically fluctuate at a specific frequency. The provisional offset value, therefore, exhibits zero crossings. Such characteristics do not always appear in the case of a valve having lower hysteresis. Also in that case, the drive quantity is not constant. However, the changes in the case of such a valve can be slow in comparison to those for higher hysteresis. As a result of these slow changes, the provisional offset value has smaller values. However, many zero crossings also occur in this case. Thus, the time between two zero crossings of the provisional offset value is determined, as shown below. For every zero crossing, a summator, which is otherwise increased by the amount of the instantaneous value of the provisional offset value for every program cycle, is set back. In response to the next zero crossing being reached, the then obtained counter status and the time between the two zero crossing of the provisional offset value are used to decide whether the maximum offset value is to be kept constant or changed, reduced in particular, e.g. halved or quartered. If the summator reaches a first threshold within a predefined time period, the maximum offset value is reduced to a first degree, preferably halved, in the preferred exemplary embodiment. If within this time a second, greater threshold value is exceeded, and the maximum offset value is above a limiting value, the maximum offset value is reduced, e.g. quartered, to a second, greater degree. To adaptively adjust the maximum offset value to the valve characteristics, the maximum offset value is increased by a certain value Δ at predefined intervals, e.g. in every fourth program run.

In the case of a valve having high hysteresis, the time between two zero crossings is greater than the predefined time, so that the maximum offset value is not reduced. By continuously increasing the maximum offset value, an offset value that is high in comparison to valves having lower hysteresis is added to the drive signal, thereby causing the valve hysteresis to be overcome, and the quantities influenced by the valve, e.g. the brake pressure or the traveling speed, to follow more quickly. The fluctuations are, therefore, reduced. If the drive signal becomes irregular due to an offset value that is too high, the time period between two zero crossings of the provisional offset value is below the predefined value. If the result of the summator is greater than one of the indicated threshold values, the maximum offset value is reduced, thereby preventing the tendency for irregularity.

In the case of a valve having lower hysteresis, this irregularity tendency is generated as a result of continuously increasing the offset value. As a result of the irregularity causing the time span between two zero crossings to decrease and become less than the predefined maximum time and at the same time causing the result of the summator to be greater than the first threshold value, the irregularity tendency is reduced, and the maximum offset value is decreased. The indicated limiting values are determined in driving tests.

The adaptation of the maximum offset value in the above-described manner is accomplished by a program implemented in microcomputer 14 and outlined in FIG. 3 as a flow chart. In this context, the program is stored in storage mediums in the microcomputer or outside of the microcomputer. This program is also executed during operation, at predefined time intervals.

In first step 200, formed, provisional offset value OFFVORL and instantaneous maximum value OFFMAX are first input. The latter is increased by a certain value A at predefined time intervals, e.g. in every fourth program run. Subsequent step 202 checks whether the provisional offset value is less than 0. If this is the case, a first mark FLAG1 is set to the value 1 (step 204). Step 206 subsequently checks whether a second mark that is set when the provisional offset value is greater than 0 is set to 1. If this is not the case, that is an indication that there was no zero crossing. If the second mark is set to 1, this is an indication that it would be detected for the first time that the provisional offset value exceeded the zero value. Therefore, a zero crossing exists. For this purpose, the second mark is set to 0 in step 208 in this case, and in subsequent step 210, summator Z is set to 0, and time counter T is started.

The program proceeds accordingly in the event that it was detected in step 202 that the provisional offset value is not less than 0. In this case, step 212 checks whether the provisional offset value is greater than 0. If this is the case, the second mark is set to 1 in step 214, and subsequent step 216 checks whether the first mark has a value of 1. If this is not the case, this is an indication of the lack of a zero crossing, while in the case of a positive response in step 216, a zero crossing from positive to negative values is assumed. For this purpose, the first mark is set to 0 in step 218 in this case, and in subsequent step 220, summator Z is set to 0, and time counter T is started.

Thus, the summator is set back for every detected zero crossing of the provisional offset value, and a time counter is started. After steps 210 and 220 or in the case of a no-response in steps 206, 212, and 216, the value of summator Z is increased by provisional offset value OFFVORL in step 222. In the preferred exemplary embodiment, this is performed by an addition. Furthermore, the time counter reading is increased in this step. Subsequent step 224 checks whether time counter reading T is less than or equal to a maximum value TMAX. That means that a check is performed to determine whether a predefined time TMAX between two zero crossings is exceeded. If time T is greater than TMAX, the maximum offset value is not changed. If the time is less than the predefined time, a check is performed in accordance with step 226 to determine whether summator reading Z exceeds a threshold value Z2. If this is the case, step 232, which is not present in other embodiments, checks in an exemplary embodiment whether the maximum offset value exceeds a limiting value OFF0. If this is also the case, maximum offset value OFFMAX is reduced in accordance with step 228 to a predetermined degree, e.g. quartered. If the counter reading is not greater than threshold value Z2, step 230 checks whether the counter reading is greater than a smaller threshold value Z1. If this is the case, the maximum offset value is reduced in accordance with step 234 to a second, smaller degree, e.g. halved.

In other words, if a predefined maximum time between two zero crossings is not exceeded, the maximum offset value is more slowly or more quickly reduced as a function of the summator reading, provided this summator reading exceeds predetermined threshold values.

After steps 228 and 234 as well as in the case of no-responses in steps 224, 230, and 232, the program is concluded and executed anew at the next time interval.

What is claimed is:

1. A method for driving a hysteresis-exhibiting final controlling element, comprising the steps of:
driving the final controlling element by a drive signal having a variable drive quantity; and
correcting the variable drive quantity as a function of a change thereof over time.

2. The method according to claim 1, further comprising the step of:
forming an offset value signal on the basis of the change over time of the variable drive quantity, wherein:
the step of correcting is performed in accordance with the offset value signal.

3. The method according to claim 2, further comprising the step of:
limiting the offset value signal to a maximum offset value.

4. The method according to claim 3, wherein:
the maximum offset value is variable and is changed as a function of zero crossings of the offset value signal.

5. The method according to claim 4, futher comprising the step of:
reducing the maximum offset value when a counter reading exceeds a predetermined threshold value within a predefined time between two of the zero crossings.

6. The method according to claim 5, wherein:
the counter reading is formed from the offset value signal.

7. The method according to claim 6, wherein:
the maximum offset value is reduced more quickly when a second, higher threshold value is exceeded.

8. The method according to claim 2, wherein:
the offset value signal corresponds to a value of the change over time of the variable drive quantity.

9. A device for driving a final controlling element exhibiting hysteresis, comprising:
a control device that includes at least one microcomputer and that forms a variable drive signal quantity for driving the final controlling element in accordance with at least one program executed by the at least one microcomputer, wherein:
the at least one program corrects the variable drive signal quantity as a function of a change thereof over time.

10. A storage medium in which a computer program is stored, the computer program causing a processing device to perform the steps of:
driving a final controlling element by a drive signal having a variable drive quantity; and
correcting the variable drive quantity as a function of a change thereof over time.
